(19) United States
(12) Patent Application Publication
(10) Pub. No.: US 2014/0184672 A1
(43) Pub. Date: Jul. 3, 2014

(54) LIQUID CRYSTAL PANEL AND LIQUID DISPLAY DEVICE WITH THE SAME

(71) Applicant: Yin-hung Chen, Shenzhen City (CN)

(72) Inventor: Yin-hung Chen, Shenzhen City (CN)

(73) Assignee: Shenzhen China Star Optoelectronics Technology Co., Ltd., Shenzhen (CN)

(21) Appl. No.: 13/811,699

(22) PCT Filed: Jan. 5, 2013
(86) PCT No.: PCT/CN13/70083

§ 371 Date: Jan. 23, 2013

(30) Foreign Application Priority Data
Dec. 28, 2012 (CN) 201210584622.4

(51) Int. Cl. G09G 3/36; G02F 1/133

(52) U.S. Cl. CPC G09G 3/3674; G02F 1/13306
USPC 345/698; 349/143; 345/87

(57) ABSTRACT

A liquid crystal panel and the liquid crystal display including the liquid crystal panel are disclosed. The liquid crystal panel include a (m×n) matrix of subpixels, and (m+2) data lines extending along a column direction, (m+2) data lines extending along a column direction, and n scanning lines extending along a row direction. The data lines of the 1st column through the ((m+2)/2)-th column control the subpixels in the 1st column through the (m/2)-th column, and the data lines of the ((m+4)/2)-th column through the (m+2)-th column control the subpixels in the ((m+2)/2)-th column through the m-th column Each of the scanning line controls one row subpixels. The high-resolution display is achieved by changing the structure of the pixel arrangement of the liquid crystal panel, instead of changing the input and the output of the timing controller.

### BACKGROUND OF THE INVENTION

1. Field of the Invention

Embodiments of the present disclosure relate to liquid crystal display technology, and more particularly to a liquid crystal panel and the liquid crystal display (LCD) with the same.

2. Discussion of the Related Art

With the development of liquid crystal technology, high resolution, large-scale, and more vivid display effect are consumer's demands. Currently, LCDs are adopted as high resolution, full color displays for a variety kind of electronic devices, such as TVs, computers, digital cameras or cellular phones.

Usually, one frame of the LCD includes a plurality of pixels with different brightness. Each pixel includes three subpixels that are respectively red (R), green (G), and blue (B). Data drivers and scanning drivers control the display of the pixels. The data drivers and the scanning drivers are controlled by control signals outputted by the timing controller. More R, G, and B subpixels are required to achieve a high-resolution image, and thus more timing controllers are also required to process information and to output control signals. However, when there are a large number of timing controllers, the input and output of the timing controller have to be changed. Alternatively, the pixel structure of the liquid crystal panel has to be changed so that the pixels of the display, such as the display with 4000×2000 resolutions, can be correctly driven.

### SUMMARY

The object of the claimed invention is to provide a high-resolution display by changing the structure of the pixel arrangement of the liquid crystal panel. With such structure, the input and the output of the timing controller have not to be changed.

In one aspect, a liquid crystal panel includes: a (m×n) matrix of subpixels; (m+2) data lines extending along a column direction, the data lines of the 1st column through the ((m+2)/2)-th column control the subpixels in the 1st column through the (m/2)-th column, and the data lines of the ((m+4)/2)-th column through the (m+2)-th column control the subpixels in the ((m+2)/2)-th column through the m-th column; and n scanning lines extending along a row direction, and each of the scanning line control one row subpixels.

Wherein a-th row subpixels in the 1st column through the (m/2)-th column connect to the data lines in a left side of the subpixels in the 1st column through the (m+2)-th column, the (a+1)-th row subpixels in the 1st column through the (m/2)-th column connect to the data lines in a right side of the subpixels in the 1st column through the (m+2)-th column, and wherein the number “a” is a natural number not larger than number n.

Wherein the b-th row subpixels in the ((m+2)/2)-th column through the m-th column connect to the data lines in the left side of the subpixels in the ((m+2)/2)-th column through the m-th column, the (b+1)-th row subpixels in the ((m+2)/2)-th column through the m-th column connect to the data lines in the right side of the subpixels in the ((m+2)/2)-th column through the m-th column, and wherein the number “b” is a natural number not larger than number n.

Wherein the (b+1)-th row subpixels in the ((m+2)/2)-th column through the m-th column connect to the data lines in the right side of the subpixels in the ((m+2)/2)-th column through the m-th column.

Wherein the subpixels in the same column are the same, and the subpixels in the same row are a first subpixel, a second subpixel, and a third subpixel interleaved arranged.

In another aspect, a liquid crystal display includes: a timing control module for outputting scanning control signals, data control signals and image information; a scanning driver for outputting scanning signals in accordance with the scanning control signals; a data driven module for transforming the image information to pixel voltages in accordance with the data control signals so as to output the pixel voltages, and a liquid crystal panel. The liquid crystal panel includes: a (m×n) matrix of subpixels; (m+2) data lines extending along a column direction, the data lines of the 1st column through the ((m+2)/2)-th column control the subpixels in the first column through the (m/2)-th column, and the data lines of the ((m+4)/2)-th column through the (m+2)-th column control the subpixels in the ((m+2)/2)-th column through the m-th column; and n scanning lines extending along a row direction, and each of the scanning line control one row subpixels.

Wherein a-th row subpixels in the 1st column through the (m/2)-th column connect to the data lines in a left side of the subpixels in the 1st column through the (m+2)-th column, the (a+1)-th row subpixels in the 1st column through the (m/2)-th column connect to the data lines in a right side of the subpixels in the 1st column through the (m+2)-th column, and wherein the number “a” is a natural number not larger than number n.

Wherein the b-th row subpixels in the ((m+2)/2)-th column through the m-th column connect to the data lines in the left side of the subpixels in the ((m+2)/2)-th column through the m-th column, the (b+1)-th row subpixels in the ((m+2)/2)-th column through the m-th column connect to the data lines in the right side of the subpixels in the ((m+2)/2)-th column through the m-th column, and wherein the number “b” is a natural number not larger than number n.

Wherein the (b+1)-th row subpixels in the ((m+2)/2)-th column through the m-th column connect to the data lines in the right side of the subpixels in the ((m+2)/2)-th column through the m-th column.

Wherein the subpixels in the same column are the same, and the subpixels in the same row are a first subpixel, a second subpixel, and a third subpixel interleaved arranged.

Wherein the timing control module includes a first timing controller and a second timing controller, the image information includes the first image information and the second image information, wherein the first timing controller outputs the scanning control signals to control the scanning driver to output synchronous signals, the second timing controller receives the synchronous signals such that the first timing controller and the second timing controller synchronously output the first image information and the second image information.

Wherein the first image information includes the image information for the subpixels in the 1st column through the (m/2)-th column, the image information for the virtual subpixels D in the left column of the 1st column subpixel, and the image information for the virtual subpixels D in the right column of the (m/2)-th column subpixel, and the second image information includes the image information for the subpixels in the ((m+2)/2)-th column through the m-th column, the image information for the virtual subpixels D in the left column of the ((m+2)/2)-th column subpixel, and image information for the virtual subpixels D in the right column of the m-th column subpixel.

Wherein the data driven module includes a first data driver and a second data driver, the data control signals includes a first data control signals and a second data control signals, wherein the first data driver and the second data driver respectively receive the first data control signals outputted from the first timing controller and the second data control signals outputted from the second timing controller.

Wherein the data driven module includes a first data driver and a second data driver, the data control signals includes a first data control signals and a second data control signals, wherein the first data driver and the second data driver respectively receive the first data control signals outputted from the first timing controller and the second data control signals outputted from the second timing controller.

### BRIEF DESCRIPTION OF THE DRAWINGS

FIG. 1 is a schematic view of the liquid crystal panel in accordance with one embodiment.

FIG. 2 is a schematic view of the liquid crystal display in accordance with one embodiment.

### DETAILED DESCRIPTION OF THE EMBODIMENTS

Embodiments of the invention will now be described more fully hereinafter with reference to the accompanying drawings, in which embodiments of the invention are shown.

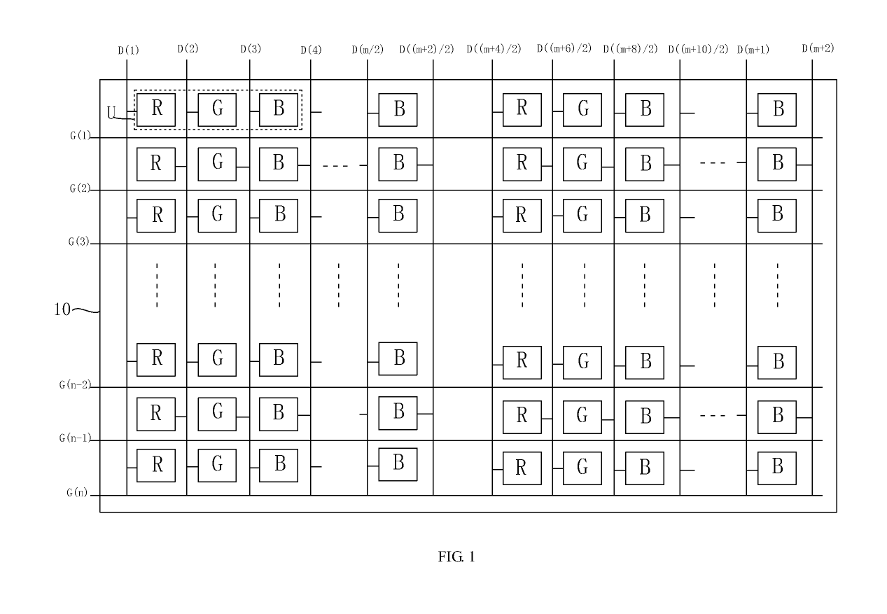

FIG. 1 is a schematic view of the liquid crystal panel in accordance with one embodiment. The liquid crystal panel supports a high resolution and includes a plurality of subpixels. Usually, such panels are adopted for high definition LCD.

Referring to FIG. 1, the liquid crystal panel 10 includes n scanning lines G(1), G(2), . . . G(n), (m+2) data lines D(1), D(2), . . . D(m+2) and a (m×n) matrix of subpixels. In the embodiment, m is an even number. In addition, each subpixel may be one of the red (R), green (G), and blue (B) color. Preferably, the subpixels in the same column are the same color.

For example, the subpixels in the same column are all R, G, or B subpixels. A subpixel unit (U) includes a first, a second, and a third subpixel that are interleaved. The first, the second, and the third subpixel may be, but not limited to, respectively R subpixel, G subpixel and B subpixel

Each scanning line G(1), G(2), . . . G(n) extends along a row direction, and is spaced apart from each other. Each data lines D(1), D(2), . . . D(m+2) extends along a column direction, and are spaced apart from each other. The subpixels are defined by the scanning lines G(1), G(2), . . . G(n) and the data lines D(1), D(2), . . . D(m+2). The subpixels are turn on by scanning pulses provided by the scanning lines G(1), G(2), . . . G(n) so as to provide pixel voltages to the subpixels from the data lines D(1), D(2), . . . D(m+2).

For example, the subpixels arranged along the row direction connect to the same scanning line G(1), G(2), . . . G(n). The subpixels arranged along the column direction alternatively connect to two adjacent data lines.

Specifically, the data lines D(1), D(2), . . . D((m+2)/2) control the subpixels in the 1st column through the (m/2)-th column The subpixels electrically connecting to the odd scanning lines G(1), G(3), G(5) . . . also electrically connect to the data lines in a left side of the subpixels in the 1st column through the (m/2)-th column On the contrary, the subpixels electrically connecting to the even scanning lines G(2), G(4), G(6). . . also electrically connect to the data lines arranged in a right side of the subpixels in the 1st column through the (m/2)-th column. In other words, the data lines D(1), D(2), . . . D((m+2)/2) alternatively connect to the subpixels at the right side and the left side.

Specifically, the data lines D((m+4)/2), D((m+6)/2), . . . , D(m+2) control the subpixels in the ((m+2)/2)-th column through the m-th column The subpixels electrically connecting to the odd scanning lines G(1), G(3), G(5) . . . also electrically connect to the data lines D((m+4)/2), D((m+8)/2), . . . D(m+1) arranged in the left side of the subpixels in the ((m+2)/2)-th column through the m-th column. On the contrary, the subpixels electrically connecting to the even scanning lines G(2), G(4), G(6) . . . also electrically connect to the data lines D((m+6)/2), D((m+10)/2), . . . D(m+2) arranged in the right side of the subpixels in the ((m+2)/2)-th column through the m-th column In other words, the data lines D((m+4)/2), D((m+6)/2), . . . , D(m+2) alternatively connect subpixels at the right side and the left side.

In addition, virtual subpixels are generated when the liquid crystal panel displays images. Specifically, the virtual subpixels D generated at the left side of the subpixels in the 1st column are in areas defining by the even scanning lines G(2), G(4), G(6). . . and the data line D(1). Similarly, the virtual subpixels D generated at the left side of the subpixels in the ((m+2)/2)-th column are in areas defining by the even scanning lines G(2), G(4), G(6). . . and the data line D((m+4)/2). The virtual subpixels D generated at the right ride of the subpixels in the (m/2)-th column are in areas defining by the even scanning lines G(1), G(3), G(5) . . . and the data line D((m+2)/2). Similarly, the virtual subpixels D generated at the right ride of the subpixels in the m-th column are in areas defining by the even scanning lines G(1), G(3), G(5) . . . and the data line D(m+2).

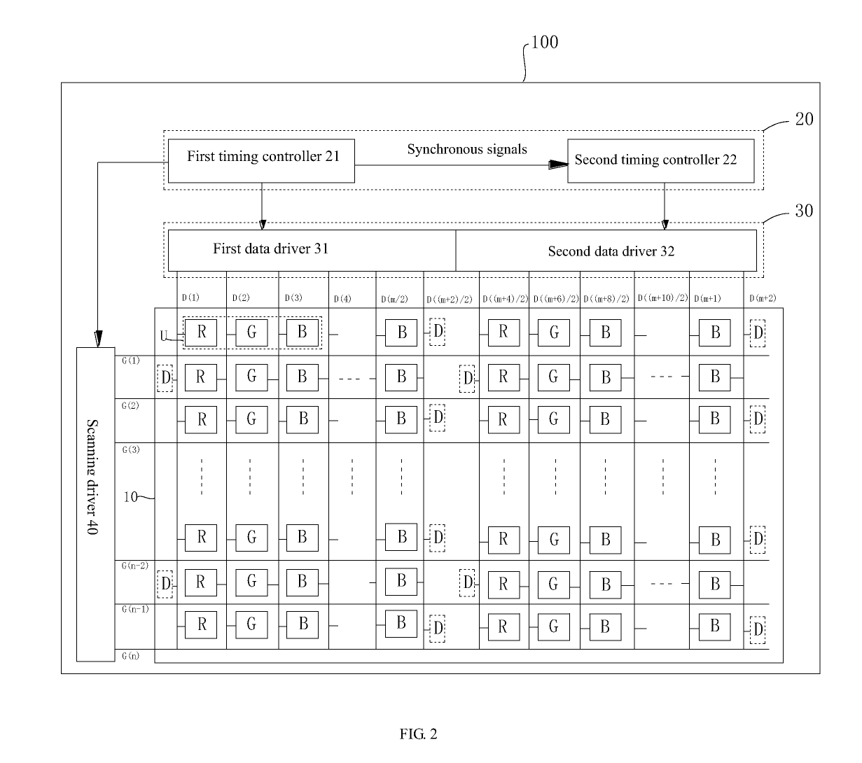

FIG. 2 is a schematic view of the liquid crystal display in accordance with one embodiment. Referring to FIG. 2, a liquid crystal display 100 includes a liquid crystal panel 10, a timing control module 20, a data driven module 30, and a scanning driver 40. In the embodiment, the liquid crystal panel 10 is the same with the liquid crystal panel in the above embodiment.

The timing control module 20 provides digital image information to the data driven module 30, and the digital image information is from an external graphic adapter (not shown). In addition, the timing control module 20 respectively provides scanning control signals and data control signals to the scanning driver 40 and the data driven module 30 by horizontal and vertical signals. The timing control module 20 includes a first timing controller 21 and a second timing controller 22. The data driven module 30 includes a first data driver 31 and a second data driver 32. The image information includes the first image information and the second image information respectively corresponding to the first timing controller 21 and the second timing controller 22. Similarly, the data control signals includes a first data control signals and a second data control signals. The first image information includes the image information for the subpixels in the 1st column through the (m/2)-th column, the image information for the virtual subpixels D in the left column of the 1st column subpixel, and the image information for the virtual subpixels D in the right column of the (m/2)-th column subpixel. The second image information includes the image information for the subpixels in the ((m+2)/2)-th column through the m-th column, the image information for the virtual subpixels D in the left column of the ((m+2)/2)-th column subpixel, and image information for the virtual subpixels D in the right column of the m-th column subpixel.

Specifically, the first timing controller 21 and the second timing controller 22 respectively provides the first image information and the second image information to the first data driver 31 and the second data driver 32, and the first image information and the second image information are provided from the external graphic adapter (not shown). In addition, the first timing controller 21 respectively provides the scanning control signals and the first data control signals to the scanning driver 40 and the first timing controller 21 by the horizontal and the vertical signals. In addition, the second timing controller 22 and the first timing controller 21 are driven by synchronous signals so as to synchronously output the vertical signals for providing the second data control signals to the second data driver 32.

The scanning driver 40 provides the scanning pulses to the scanning lines G(1), G(2), . . . G(n). The scanning pulses are provided by the first timing controller 21. The scanning pulses turn on the subpixels electrically connected to the same scanning lines along the vertical direction one by one such that the first image information and the second image information are selected to apply to the scanning lines.

The first data driver 31 provides the first image information to the data lines D(1), D(2), . . . D((m+2)/2) via the first data control signals provided by the first timing controller 21. The first data driver 31 transforms the first image information to a number of pixel voltages, and the pixel voltages are analog. The number of the pixel voltages corresponds to the number of the subpixels in the first column through the (m/2)-th column, the number of the virtual subpixels D in the left column of the first column subpixels, and the number of the virtual subpixel D in the right column of the (m/2)-th column subpixels. In addition, the first data driver 31 provides the plurality of pixel voltages to the data lines D(1), D(2), . . . D(m+2) in response to the scanning pulses. The pixel voltages are supplied to the subpixels in the first column through the (m/2)-th column, the virtual subpixels D in the left column of the first column subpixels, and the virtual subpixel D in the right column of the (m/2)-th column subpixels.

Synchronously, the second data driver 32 provides the second image information to the data lines D((m+4)/2), D((m+6)/2), . . . D(m+2) via the second data control signals provided by the second timing controller 22. The second data driver 32 transforms the second image information to a number of pixel voltages, and the pixel voltages are analog. The number of the pixel voltages corresponds to the number of the subpixels in the ((m+2)/2)-th column through the m-th column, the number of the virtual subpixels D in the left column of the ((m+2)/2)-th column subpixels, and the number of the virtual subpixel D in the right column of the m-th column subpixels. In addition, the second data driver 32 provides the plurality of pixel voltages to the data lines D((m+4)/2), D((m+6)/2), . . . D(m+2) in response to the scanning pulses. The pixel voltages are supplied to the subpixels in the ((m+2)/2)-th column through the m-th column, the virtual subpixels D in the left column of the ((m+2)/2)-th column subpixels, and the virtual subpixel D in the right column of the m-th column subpixels.

In view of the above, the data lines D(1), D(2), . . . D((m+2)/2)) control the subpixels in the first column through the (m/2)-th column, and the data lines D((m+4)/2), D((m+6)/2), . . . D(m+2) control the subpixels in the ((m+2)/2)-th column through the m-th column In this way, the liquid crystal display is capable of displaying with the high resolution without changing the input and the output of the timing control module.

It is believed that the present embodiments and their advantages will be understood from the foregoing description, and it will be apparent that various changes may be made thereto without departing from the spirit and scope of the invention or sacrificing all of its material advantages, the examples hereinbefore described merely being preferred or exemplary embodiments of the invention.

What is claimed is:

1. A liquid crystal panel, comprising:
a (m×n) matrix of subpixels;
(m+2) data lines extending along a column direction, the data lines of the 1st column through the ((m+2)/2)-th column control the subpixels in the 1st column through the (m/2)-th column, and the data lines of the ((m+4)/2)-th column through the (m+2)-th column control the subpixels in the ((m+2)/2)-th column through the m-th column; and
n scanning lines extending along a row direction, and each of the scanning line control one row subpixels.

2. The liquid crystal panel as claimed in claim 1, wherein a-th row subpixels in the 1st column through the (m/2)-th column connect to the data lines in a left side of the subpixels in the 1st column through the (m+2)-th column, the (a+1)-th row subpixels in the 1st column through the (m/2)-th column connect to the data lines in a right side of the subpixels in the 1st column through the (m+2)-th column, and wherein the number “a” is a natural number not larger than the number n.

3. The liquid crystal panel as claimed in claim 2, wherein the b-th row subpixels in the ((m+2)/2)-th column through the m-th column connect to the data lines in the left side of the subpixels in the ((m+2)/2)-th column through the m-th column, the (b+1)-th row subpixels in the ((m+2)/2)-th column through the m-th column connect to the data lines in the right side of the subpixels in the ((m+2)/2)-th column through the m-th column, and wherein the number “b” is a natural number not larger than number n.

4. The liquid crystal panel as claimed in claim 3, wherein the (b+1)-th row subpixels in the ((m+2)/2)-th column through the m-th column connect to the data lines in the right side of the subpixels in the ((m+2)/2)-th column through the m-th column.

5. The liquid crystal panel as claimed in claim 1, wherein the subpixels in the same column are the same, and the subpixels in the same row are a first subpixel, a second subpixel, and a third subpixel interleaved arranged.

6. A liquid crystal display, comprising:
a timing control module for outputting scanning control signals, data control signals and image information;
a scanning driver for outputting scanning signals in accordance with the scanning control signals;
a data driven module for transforming the image information to pixel voltages in accordance with the data control signals so as to output the pixel voltages, and a liquid crystal panel comprises:
a (m×n) matrix of subpixels;
(m+2) data lines extending along a column direction, the data lines of the 1st column through the ((m+2)/2)-th column control the subpixels in the first column through the (m/2)-th column, and the data lines of the ((m+4)/2)-th column through the (m+2)-th column control the subpixels in the ((m+2)/2)-th column through the m-th column; and
n scanning lines extending along a row direction, and each of the scanning line control one row subpixels.

7. The liquid crystal display as claimed in claim 6, wherein a-th row subpixels in the 1st column through the (m/2)-th column connect to the data lines in a left side of the subpixels in the 1st column through the (m+2)-th column, the (a+1)-th row subpixels in the 1st column through the (m/2)-th column connect to the data lines in a right side of the subpixels in the 1st column through the (m+2)-th column, and wherein the number “a” is a natural number not larger than number n.

8. The liquid crystal display as claimed in claim 7, wherein the b-th row subpixels in the ((m+2)/2)-th column through the m-th column connect to the data lines in the left side of the subpixels in the ((m+2)/2)-th column through the m-th column, the (b+1)-th row subpixels in the ((m+2)/2)-th column through the m-th column connects to the data lines in the right side of the subpixels in the ((m+2)/2)-th column through the m-th column, and wherein the number “b” is a natural number not larger than number n.

9. The liquid crystal display as claimed in claim 8, wherein the (b+1)-th row subpixels in the ((m+2)/2)-th column through the m-th column connect to the data lines in the right side of the subpixels in the ((m+2)/2)-th column through the m-th column.

10. The liquid crystal display as claimed in claim 6, wherein the subpixels in the same column are the same, and the subpixels in the same row are a first subpixel, a second subpixel, and a third subpixel interleaved arranged.

11. The liquid crystal display as claimed in claim 6, wherein the timing control module comprises a first timing controller and a second timing controller, the image information includes the first image information and the second image information, wherein the first timing controller outputs the scanning control signals to control the scanning driver to output synchronous signals, the second timing controller receives the synchronous signals such that the first timing controller and the second timing controller synchronously output the first image information and the second image information.

12. The liquid crystal display as claimed in claim 11, wherein the first image information comprises the image information for the subpixels in the 1st column through the (m/2)-th column, the image information for the virtual subpixels D in the left column of the 1st column subpixel, and the image information for the virtual subpixels D in the right column of the (m/2)-th column subpixel, and the second image information comprises the image information for the subpixels in the ((m+2)/2)-th column through the m-th column, the image information for the virtual subpixels D in the left column of the ((m+2)/2)-th column subpixel, and image information for the virtual subpixels D in the right column of the m-th column subpixel.

13. The liquid crystal display as claimed in claim 12, wherein the data driven module comprises a first data driver and a second data driver, the data control signals comprises a first data control signals and a second data control signals, wherein the first data driver and the second data driver respectively receive the first data control signals outputted from the first timing controller and the second data control signals outputted from the second timing controller.

14. The liquid crystal display as claimed in claim 13, wherein the data driven module comprises a first data driver and a second data driver, the data control signals comprises a first data control signals and a second data control signals, wherein the first data driver and the second data driver respectively receive the first data control signals outputted from the first timing controller and the second data control signals outputted from the second timing controller.
